(19) United States
(12) Patent Application Publication
(10) Pub. No.: US 2013/0222344 A1
(43) Pub. Date: Aug. 29, 2013

(54) OPTICAL TOUCH MODULE

(71) Applicants: HSUEH-YU LU, New Taipei City (TW); Ke-Feng Lin, New Taipei City (TW)

(72) Inventors: HSUEH-YU LU, New Taipei City (TW); Ke-Feng Lin, New Taipei City (TW)

(73) Assignee: Cheng Uei Precision Industry Co., LTD., New Taipei City (TW)

(21) Appl. No.: 13/405,351

(22) Filed: Feb. 26, 2012

(51) Int. Cl. G06F 3/042

(52) U.S. Cl. 345/175

(57) ABSTRACT

An optical touch module includes a frame having an assembling wall and a plurality of side walls, and an operating space. The assembling wall has an inner wall face. A display device is disposed inside the frame, and an interval is formed between a margin of the display device and the inner wall face and spatially communicates with the operating space. At least a light sensing device located inside the interval has a fixed part and a detection part. At least a signal processing device is electrically connected to the At least alight sensing device. At least a reflective element has a reflective surface located at a same horizontal plane as the detection part and facing toward the operating space. The optical touch module of the present invention is able to be calibrated or repaired at a front frame of the display device without causing damages to the display device.

### BACKGROUND OF THE INVENTION

1. Field of the Invention

The present invention generally relates to a touch module, and in particular to an optical touch module having a simple structure and reduced thickness.

2. The Related Arts

A touch panel can be directly controlled through touch operations. As a result, its applications range increasingly wider, and it is applicable from small size panels to large size panels. Common touch control technology varies, such as the resistive type, the capacitive type or the Surface Acoustic Wave (SAW) type, etc. However, in view of cost and efficiency, the optical touch types are much advantaged of accuracy, high penetration rates, low damage rates, low production cost and being supportive to multiple touch control gestures and so on.

The optical touch technology is in use of the principle of light received and interrupted. Through coordination of sensors and reflective pieces of optical touch modules, precise touch positions can be read by processing devices when objects interrupt light, and the sensors detect such changes and transmit related signals to the processing devices. However, traditional optical touch modules are installed on touch panels. The touch panels are easy to be damaged when the modules are in need of calibration or repair. Besides, the processing devices are usually installed on bases of the touch panels or other structures. As a result, signal transmission paths thereof are much longer and tend to affect transmission speed thereof, to occupy more space, and to relative increase manufacturing costs.

### SUMMARY OF THE INVENTION

An objective of the present invention is to provide an optical touch module having advantages of convenient calibration, easy maintenance and saving space required for installation.

To achieve the above objective, an optical touch module of the present invention comprises a frame comprising at least an assembling wall and a plurality of side walls adjacent to each other. An operating space is cooperatively formed by the assembling wall and the plurality of side walls, and the assembling wall comprises an inner wall face. A display device is disposed inside the frame, and an interval is formed between a margin of the display device and the inner wall face of the assembling wall while the interval spatially communicates with the operating space. At least a light sensing device comprises a fixed part and a detection part, and the at least a light sensing device is located inside the interval. At least a signal processing device is disposed on the assembling wall and electrically connected to the At least a light sensing device. Finally, At least a reflective element is disposed on the plurality of side walls, and comprises a reflective surface defined in a same horizontal plane as the detection part and facing toward the operating space.

As described above, the optical touch module of the present invention has advantages of significantly saving space required for installation, and being able to calibrate or repair the light sensing device, the reflective element and the signal processing device thereof at the front frame of the display screen (i.e., display device) without damages to the display device.

### BRIEF DESCRIPTION OF THE DRAWINGS

FIG. 1 is a schematic cross-sectional view of the first embodiment of the present invention;

FIG. 2 is a schematic cross-sectional view of the second embodiment of the present invention; and

FIG. 3 is a schematic cross-sectional view of the third embodiment of the present invention.

### DETAILED DESCRIPTION OF PREFERRED EMBODIMENT

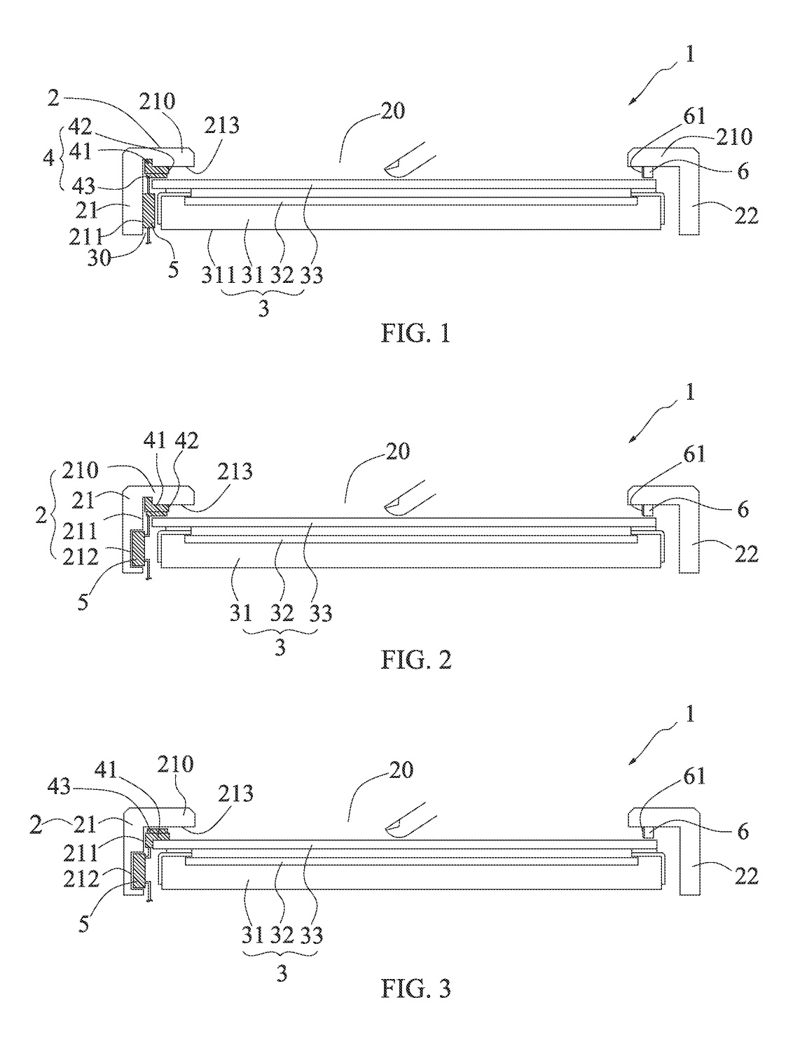

With reference to FIG. 1, the first embodiment of the present invention is shown in a schematic cross-sectional view. An optical touch module 1 of the present invention is used for image display and is operated or controlled by single-point or multiple-point touch control.

The optical touch module 1 comprises a frame 2, a display device 3, two light sensing devices 4, a signal control device 5, and a plurality of reflective elements 6. The frame 2 comprises an assembling wall 21 and a plurality of side walls 22 connected with each other, and a rectangular frame is formed by the assembling wall 21 and the plurality of side walls 22 to define an operating space 20 therein. Frame edges 210 protrude into the operating space 20 from the assembling wall 21 and the plurality of side walls 22 respectively. The assembling wall 21 comprises an inner wall face 211, which extends to the frame edge 210 corresponding to the assembling wall 21. The assembling wall 21 and the corresponding frame edge 210 form a profile of an inverted “L” together in a cross sectional view thereof.

The display device 3 is assembled inside the frame 2, and comprises a base 31, a touch screen 33 and a display panel 32 located between the base 31 and the touch screen 33. The display panel 32 is directly installed above the base 31 and is a liquid crystal display (LCD). The touch screen 33 is made by transparent material. In particular, the margin of the display device 3 and the frame 2 form an interval 30 spatially communicating with the operating space 20. The frame edge 210 is located above the interval 30, and the inner surface 213 inside the frame edge 210 is parallel to the touch screen 33 (Referring to FIG. 1).

Further refer to FIG. 1, in this embodiment, the optical touch module 1 of the present invention comprises two light sensing devices 4 respectively located inside the interval 30 and installed on the inner surface 213 of the frame edge 210. In other words, the frame edge 210 is located above the light sensing devices 4 to function as a cover and protection of the light sensing devices 4. Each of the light sensing devices 4 comprises a fixed part 41, a detection part 42, and a light emitting element 43. The light emitting element 43 is a light source of the optical touch module 1 of the present invention, and can be a light emitting diode (LED) element. The light emitting element 43 is disposed on or adjacent to the detection part 42. The detection part 42 is a camera device facing toward the operating space 20. The fixed part 41 is used for fixing the light sensing devices 4 and is partially embedded inside the frame edge 210 and keeps space from the touch screen 33. Each of the plurality of reflective elements 6 comprises a reflective surface 61. In this embodiment, the plurality of reflective elements 6 can be reflective strips distributed over the plurality of side walls 22 of the frame 2. The reflective surface 61 is roughly located at the same horizontal plane as the detection part 42, and aims at the detection part 42. In this embodiment, light emitted from the LED light emitting element 43 passes through the operating space 20 to the reflective elements 6, and the detection part 42 detects and senses the light reflected by the reflection strips of the plurality of reflective elements 6.

The signal processing device 5 is used for receiving signals from the detection part 42 based on its detecting and sensing, and performs logical calculations for them. The signal processing device 5 is disposed on the inner wall face 211 of the assembling wall 21 of the frame 2, and is electrically connected with the light sensing device 4 by a connecting wire (Referring to FIG. 1). In particular, the signal processing device 5 is located in a relative position of the inner wall face 211 of the assembling wall 21 between the touch screen 33 and a bottom surface 311 of the base 31, i.e., located under the touch screen 33 so as to use interval space effectively formed between the display device 3 and the frame 2.

With reference to FIG. 2 showing the second embodiment of the present invention, the inner wall face 211 of the assembling wall 21 of the frame 2 is recessed to form a slot room 212 spatially communicating with the interval 30. The signal processing device 5 is disposed inside the slot room 212 to further save space required for installation. In addition, referring to FIG. 3 showing the third embodiment of the present invention, the light sensing device 4 can also be installed on the touch screen 33, and the signal processing device 5 is installed inside the slot room 212.

In use of the present invention, through the principle of light received and interrupted, when there are objects (such as fingers) interrupting light of the operating space 20 and touching the touch screen 33, the detection part 42 of the light sensing device 4 detects shading change and transmits related signals to the signal processing device 5. The signal processing device 5 then operates calculations and precisely determines the touched location.

Accordingly, the light sensing device 4, the signal processing device 5 and the plurality of reflective elements 6 of the optical touch module 1 of the present invention are all installed on the frame 2. It can significantly save space required for installation by using the interval 30 effectively formed between the display device 3 and the frame 2. Besides, calibration and repair can be performed at a front frame of the display screen (i.e., display device) without damages to the display device 3.

The above detailed descriptions are only illustrative for one feasible embodiment of the present invention. However, the illustrative embodiment is not intended to limit the scope of claims of the present invention. It is apparent to those skilled in the art that a variety of modifications and changes may be made without departing from the scope of claims of the present invention which is intended to be defined by the appended claims.

What is claimed is:

1. An optical touch module, comprising:
a frame, comprising at least an assembling wall and a plurality of side walls connected with each other, an operating space being cooperatively formed by the assembling wall and the plurality of side walls, and the assembling wall comprising an inner wall face;
a display device disposed inside the frame, an interval being formed between a margin of the display device and the inner wall face of the assembling wall, and spatially communicating with the operating space;
at least a light sensing device comprising a fixed part and a detection part, and the at least a light sensing device being located inside the interval;
at least a signal processing device disposed on the assembling wall and electrically connected to the at least a light sensing device; and
at least a reflective element disposed on the plurality of side walls, and comprising a reflective surface located at a same horizontal plane as the detection part and facing toward the operating space.

2. The optical touch module as claimed in claim 1, wherein the assembling wall of the frame protrudes a frame edge into the operating space, the frame edge is located above the interval, and an inner wall face of the frame edge is parallel to the display device.

3. The optical touch module as claimed in claim 2, wherein the fixed part of the at least a light sensing device is embedded inside the frame edge and spaced from the display device.

4. The optical touch module as claimed in claim 1, wherein the inner wall face of the assembling wall is recessed to form a slot room, and the At least a signal processing device is located inside the slot room.

5. The optical touch module as claimed in claim 1, wherein the display device comprises a base, a touch screen and a display panel located between the base and the touch screen, the display panel is disposed on the base, and the touch screen is made by transparent material.

6. The optical touch module as claimed in claim 5, wherein the at least a signal processing device is disposed in a relative position of the assembling wall between the touch screen and a bottom surface of the base.

7. The optical touch module as claimed in claim 6, wherein the display panel is a liquid crystal display.

8. The optical touch module as claimed in claim 1, wherein the at least a light sensing device comprises a light emitting element.
